(19) United States
(12) Patent Application Publication
(10) Pub. No.: US 2005/0213270 A1
(43) Pub. Date: Sep. 29, 2005

(54) Optical receiver

(75) Inventor: Takayuki Shimizu, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/090,225

(22) Filed: Mar. 28, 2005

(30) Foreign Application Priority Data
Mar. 29, 2004 (JP) 2004-096779

(51) Int. Cl. H02H 3/00

(52) U.S. Cl. 361/42

(57) ABSTRACT

An optical receiver of the present invention has (a) a filter circuit for separating low/high frequency current in order to separate a low frequency current component and a high frequency current component from a current signal generated by a light receiving device, (b) a current/voltage converter circuit for converting low frequency current into voltage, and (c) a bias circuit for activating a signal processing circuit according to output of the current/voltage converter circuit. Accordingly, it is possible to make current consumption of the optical receiver substantially 0 (close to leak current of a device) when there is no light signal. This makes it possible to realize an optical receiver that is so effective in lowering the power consumption that it does not need a shut-down signal from outside in order to attain lower power consumption. This achieves the optical receiver in which current running during a waiting mode is reduced.

This Nonprovisional application claims priority under 35 U.S.C. § 119(a) on Patent Application No. 96779/2004 filed in Japan on Mar. 29, 2004, the entire contents of which are hereby incorporated by reference.

### FIELD OF THE INVENTION

The present invention relates to an optical receiver which converts an optical signal into an electrical signal.

### BACKGROUND OF THE INVENTION

Especially the use of an optical fiber link for converting an optical signal into an electrical signal in musical devices is prevailing in general household. In this use, the optical fiber link is used for converting an optical signal into an electrical signal. Via the optical fiber link, an optical digital signal is sent into and out of such devices as CD, MD, and DVD players, amplifiers and others. A light emitting/receiving device is used in the optical fiber link. Because the optical fiber link is becoming widely used in recent years to carry musical signals to laptops, cellular phones, MP3 players, and other portable devices, reducing electrical power consumption in order to lengthen the duration of batteries is required to a device for use in the optical fiber link.

Besides, an optical fiber is excellent in its lightness and noise resistance and has come into practical use in an in-vehicle fiber link standardized by MOST (Media Oriented Systems Transport) or IDB1394 (Intellectual transportation system Data Bus).

FIGS. 7 and 8 illustrate conventional optical receivers which make use of the method to switch from a waiting mode to an operating mode and vice versa by determining existence of an input light signal.

Referring to FIG. 7, the conventional optical receiver has a photodiode PD1, and an amplifier AMP1. The photodiode PD1 is used for detecting a light signal. According to output of a comparator COMP1 for reading an output level of AMP1, the power supply circuit 103 supplies or stops power to AMP2 and COMP2 for signal processing. Therefore, when a light signal comes in, a receiving circuit (a light signal detecting circuit) 101 for detecting incident light switches a receiving circuit (light signal detecting circuit) 102 for signal processing from a waiting mode to an operating mode.

Illustrated in FIG. 8 is another conventional example of an optical receiver which has shutdown function. When a light signal comes in a photodiode in FIG. 8, R1 causes a voltage drop. This voltage drop switches on P-channel MOSFETs (Metal-Oxide Semiconductor Field Effect Transistors) MP1 and MP2 thereby supplying current to an amplifier AMP1 and a waveform shaping circuit COMP1 so as to switch the receiving circuit to an operating mode. There is a drawback that this case cannot be applied to a receiving circuit in which an anode of a photodiode is connected to GND.

The documents of conventional arts are publications of patent applications; Tokukai 2002-280971 published on Sep. 27, 2002 and Tokukai 2000-078091 published on Mar. 14, 2000.

However, the configuration illustrated in FIG. 7 requires a current supply during a waiting mode by necessity of making an amplifier AMP1 and COMP1 work to detect light even when a light signal doesn't come in.

In the case of using OPIC (Optical IC (Registered Trademark)), an increase in chip area becomes a demerit because the number of parts increases by necessity of preparing an additional photodiode to detect a light signal.

### SUMMARY OF THE INVENTION

It is an object of the invention to provide an optical receiver wherein current running during waiting mode can be reduced.

To accomplish the object above, an optical receiver of the present invention includes a filter circuit for separating low frequency current and high frequency current from a current signal generated by the light receiving device, a current/voltage converter for converting the low frequency current to voltage, and a bias circuit for activating a signal processing circuit in response to output of the current/voltage converter circuit, in an optical receiver equipped with a signal processing circuit for performing output process for data received by a light receiving device.

By the configuration mentioned above, the current signal generated by the light receiving device is separated into low frequency current and high frequency current and the low frequency current is converted to voltage. The output of this voltage activates a signal processing circuit. If the resulting voltage converted from the low frequency current is less than a certain level, the output changes the signal processing circuit to a waiting mode. Accordingly, the signal processing circuit can be activated based on how large the low frequency current generated in the light receiving device is. Unlike conventional art, the present invention dose not need a configuration wherein current always runs through the circuit to detect light during a waiting mode. Therefore, with the present invention, it is possible to realize an optical receiver or an optical-fiber-link-use optical receiver (an optical receiver for an optical fiber link) in which current running during a waiting mode is low.

Moreover, by the configuration mentioned above, the existence of light is determined by the fact that the light receiving device for signal processing receives light. Accordingly, this eliminates the necessity to prepare an additional device to detect light during a waiting mode, in other word, a photodiode to detect light signals. Therefore, an increase in chip area can be prevented in case of OPIC.

The optical receiver of the present invention, in addition to the configuration above, is arranged such that the filter circuit includes a resister, a capacitor, and a grounding switch device. The resister and the capacitor are connected to the light receiving device so that the light receiving device is connected with the signal processing circuit via the capacitor. The grounding switch device is provided between the capacitor and the signal processing circuit and being switched over by the bias circuit so that the ground switch device is switched to be grounded during a waiting mode.

In the configuration mentioned above, the light receiving device is connected with a resister and a capacitor in the filter circuit mentioned above. This, in addition to the advantage of the configuration mentioned above, shows an advantage that a simple configuration makes it possible to separate a current signal generated by the light receiving device into low frequency current and high frequency current.

The optical receiver of the present invention, in addition to the configuration mentioned above, is arranged such that the signal processing circuit includes a first current/voltage converter circuit and a second current/voltage converter circuit following the first current/voltage converter circuit and has input impedance lowered when the first current/voltage converter circuit is activated.

In the configuration mentioned above, the impedance lowers when the first current/voltage converter circuit of the signal processing circuit is activated. Accordingly, the capacitor is grounded during an operating mode as well as a waiting mode. Therefore, in addition to the advantage of the configuration mentioned above, it becomes an advantage that the change in property, such as cut off frequency and the like, of a filter circuit during a waiting mode and an operating mode can be decreased.

The optical receiver of the present invention, in addition to the configuration mentioned above, is arranged such that a compressor circuit is parallel-connected with a resister attached to the light receiving device.

In the configuration mentioned above, a compressor circuit is connected parallel to a resister attached to the light receiving device.

Accordingly, even when a light signal of high intensity light is inputted, a big voltage drop of a resister connected to the light receiving device can be prevented. Therefore, in addition to the advantage of the configuration mentioned above, it is possible to prevent the processing speed decrease caused by the increase in parasitic capacitance of a light receiving device in the case that bias voltage of the light receiving device lowers.

The optical receiver of the present invention, in addition to the configuration mentioned above, is arranged such that a two-way compressor circuit is parallel-connected with a feedback resister of the first current/voltage converter circuit in the signal processing circuit.

With the configuration mentioned above, a two-way compressor circuit is parallel-connected with a feedback resister of the first current/voltage converter circuit in the signal processing circuit.

Accordingly, in addition to the advantage mentioned above, the increase in the distortion of the output pulse width can be reduced when the light signal of high intensity light is inputted.

Besides, by the configuration mentioned above, two-way compression is carried out. This makes it possible to have the threshold come to exactly 50% of the signal. Therefore, in addition to the advantage of the configuration mentioned above, it becomes an advantage that the distortion of the output pulse width can be reduced.

The optical receiver of the present invention, in addition to the configuration mentioned above, is arranged such that the current/voltage converter circuit includes a current mirror for amplifying current, a resister for voltage conversion and a comparator for outputting an instruction to a bias circuit, when voltage across said resister for voltage conversion surpasses a certain level of voltage, in order to switch the signal processing circuit to an operating mode.

In the configuration mentioned above, current is amplified by a current mirror, the current is converted to voltage by a resister, and a comparator is connected. The comparator outputs an instruction to a bias circuit in order to switch a signal processing circuit to an operating mode when voltage across the resister surpasses a certain level of voltage. Accordingly, in addition to the advantage of the configuration mentioned above, it is possible to switch the signal processing circuit to an operating mode in response to the existence of a light signal, by employing a simple configuration.

The optical receiver of the present invention, in addition to the configuration mentioned above, is arranged such that in the optical receiver output of the comparator is outputted to outside as a status signal.

By the configuration mentioned above, output of the comparator is outputted to outside as a status signal. Accordingly, in addition to the advantage of the configuration mentioned above, the versatility can be improved because it is possible to add, according to circumstances, a process to delay output of the comparator and the like.

The optical receiver of the present invention, in addition to the configuration mentioned above, is arranged such that the output of the comparator is outputted as a status signal to outside through a delay circuit that has a time constant longer than time the signal processing circuit takes to become stable.

In the configuration mentioned above, output of the comparator is outputted as a status signal to outside through a delay circuit that has a time constant longer than time the signal processing circuit takes to become stable. Accordingly, this shows an advantage that a system can be more stabilized by outputting a status signal as a signal which activates a microcomputer (controller) connected (directly or indirectly) to an OUT terminal, after the signal processing circuit becomes stable enough.

The optical receiver, in addition to the configuration mentioned above, includes an output controlling circuit between output of the signal processing circuit and a signal output terminal, the output controlling circuit for causing the signal output terminal to output a signal from the signal processing circuit therethrough only when duty ratio and frequency of the signal to be outputted from the signal processing circuit are respectively equal to designated duty ratio and frequency which an output signal of the signal processing circuit has when an inputted light signal is a designated and desired correct modulation signal.

In the configuration mentioned above, between output of the signal processing circuit and a signal output terminal, an output controlling circuit is connected. Only when duty ratio and frequency of the signal to be outputted from the signal processing circuit are respectively equal to designated duty ratio and frequency which an output signal of the signal processing circuit has when an inputted light signal is a designated and desired correct modulation signal, the output controlling circuit is turned on and a signal is outputted to a signal output terminal. Accordingly, only when an input light signal is a correct modulation signal designated and desired, the signal output terminal can transmit an output signal. Therefore, in addition to the advantage of the configuration, an unnecessary output can be omitted and efficiency can be improved.

The optical receiver of the present invention, in addition to the configuration mentioned above, includes a monitor terminal for monitoring intensity of light that comes in a light receiving device and a current mirror and a resister. The current mirror and the resister are connected each other.

With the configuration mentioned above, the intensity of a light signal that comes in the light receiving device is monitored. In addition to the advantages of the configuration mentioned, the versatility can be improved because it is possible to add, according to circumstances, a process to delay the output of the comparator and the like shows up.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram of an exemplary configuration of an optical receiver according to the present invention.

FIG. 2 is a photoelectric current waveform of a light receiving device.

FIG. 3 is a circuit diagram of an exemplary configuration of an optical receiver according to the present invention.

FIG. 4 is a circuit diagram of an exemplary configuration of an optical receiver according to the present invention.

FIG. 5 is a circuit diagram of an exemplary configuration of an optical receiver according to the present invention.

FIG. 6 is a circuit diagram of an exemplary configuration of an optical receiver according to the present invention.

FIG. 7 is a circuit diagram of an exemplary configuration of a conventional optical receiver.

FIG. 8 is a circuit diagram of an exemplary configuration of a conventional optical receiver.

### DESCRIPTION OF THE EMBODIMENTS

### Embodiment 1

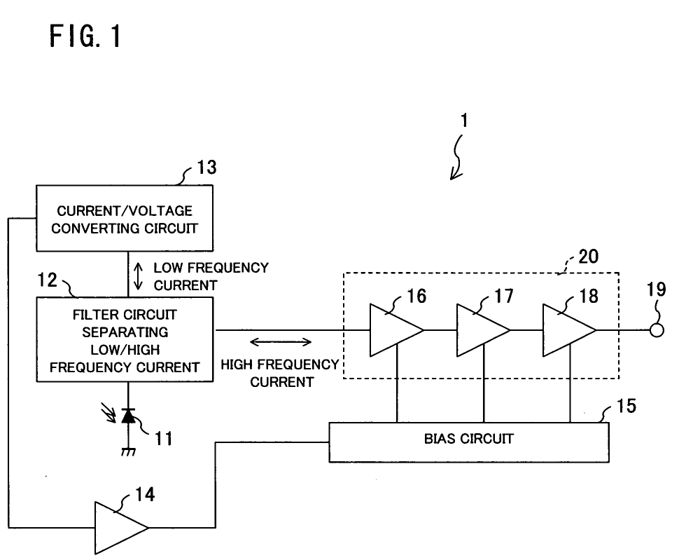

FIG. 1 is a block diagram of an optical receiver 1 to show an exemplary optical receiver of the present invention. A light receiving device 11 converts, into a current signal, a light signal that has been carried through a fiber cable or the like from outside. The current signal from the light receiving device is separated into a low frequency component that is close to a DC component in a current signal, and a high frequency component that contains a data row by a low/high frequency current separating filter circuit 12.

The low frequency component is converted from current to voltage by a current/voltage converter circuit 13, is put into a comparator 14, and is input into a bias circuit 15.

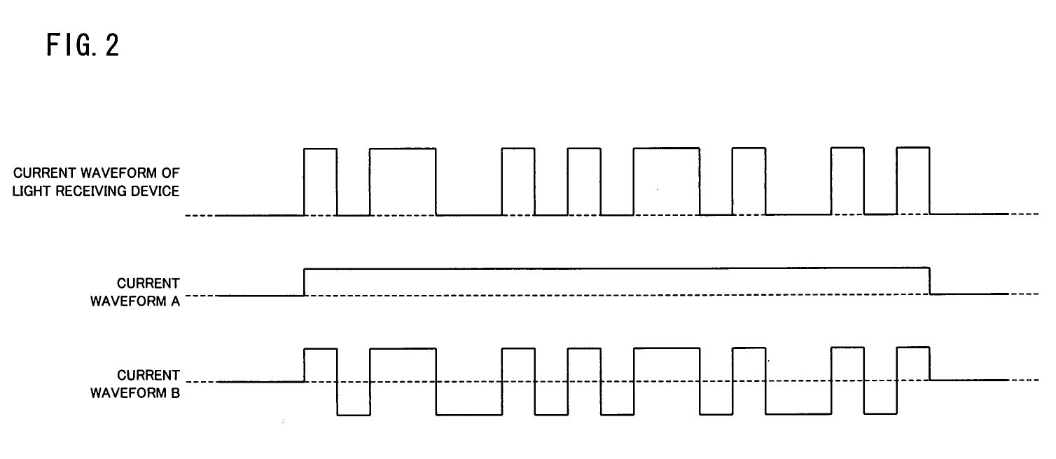

Referring to FIG. 2, a current component of the light receiving device is explained more in details. A current waveform of the light receiving device shown in FIG. 2 appears when a light signal obtained by bi-phase mark modulation comes to the light receiving device. The bi-phase mark is used for an optical fiber link for digital audio, in-vehicle MOST and the like. The waveform in FIG. 2 appears when the incoming data row is “1001101011.”

This current waveform of the light receiving device is separated into a low frequency component and a high frequency component by using a filter circuit. The current waveform is originally binary and has high and low (zero) level. By using the filter circuit, a DC current component (a low current frequency component) (a current waveform A) is added to the current waveform that has a binary waveform with the same absolute value and the opposite polarity to leave a high current frequency component. Therefore, the current waveform of the light receiving device is a sum of a current waveform A and a current waveform B. The current waveform A is the low frequency component. When the length of the data row is long enough, it becomes a component of DC current. The current waveform B is a high frequency component and is a signal carrying information of a data row.

When a light signal comes in the light receiving device and the current waveform of the light receiving device is as illustrated in FIG. 2, the low frequency current that is equivalent to the current waveform A is converted to voltage by the current/voltage converter circuit 13 as explained above. When the voltage surpasses a certain level, output of the comparator 14 is inverted. Accordingly, the bias circuit 15 is switched from a waiting mode to an operating mode. As the result, bias current is supplied to a first amplifier 16, a second amplifier 17 and a comparator 18, so as to activate a signal processing circuit 20.

On the other hand, the high frequency current with a data row is converted from current to voltage by the first amplifier 16 and is further amplified by the second amplifier 17. Then, a waveform of the thus amplified voltage is shaped by the comparator 18. After that, the voltage is output as a digital signal to a signal output terminal 19.

When supply of a light signal to the light receiving device is stopped, a current waveform (as shown in FIG. 2) of the light receiving device disappears. As a result, a low frequency current component and a high frequency current component separated from the current waveform by using the filter circuit, comes to be “always 0.” Thus, the current to voltage conversion of the low frequency current component by using the current/voltage converter circuit 13 also gives zero voltage always “always 0”. This does not satisfy “the condition of surpassing a certain level.” Then, output of the comparator 14 stops being inverted and this switches the bias circuit 15 from an operating mode to a waiting mode. This stops supply of the bias current to the first amplifier 15, the second amplifier 17, and the comparator 18. As a result, the signal processing circuit 20 stops operating and goes into a waiting mode. In this way, the bias circuit 15 stops the supply of the bias current to each signal processing circuit block during a waiting mode. Namely, no current is supplied to the sections for outputting a signal (high frequency current component) that corresponds to a data row when it comes to a waiting mode. To be more precise, the current flow keeps the amount as low as leak current of a device.

In this manner, by detecting a low frequency current component of a transmitted signal, the optical receiver is switched to an operating mode when a light signal comes in the light receiving device and is switched to a waiting mode when input of a light signal doesn't occur. This makes it possible to achieve the optical receiver that has low electrical power consumption. This optical receiver is suitable to battery operation. The light receiving device and the optical receiver can be made in a form of one monolithic IC chip as OPIC. This is advantageous to downsizing the receiver.

### Embodiment 2

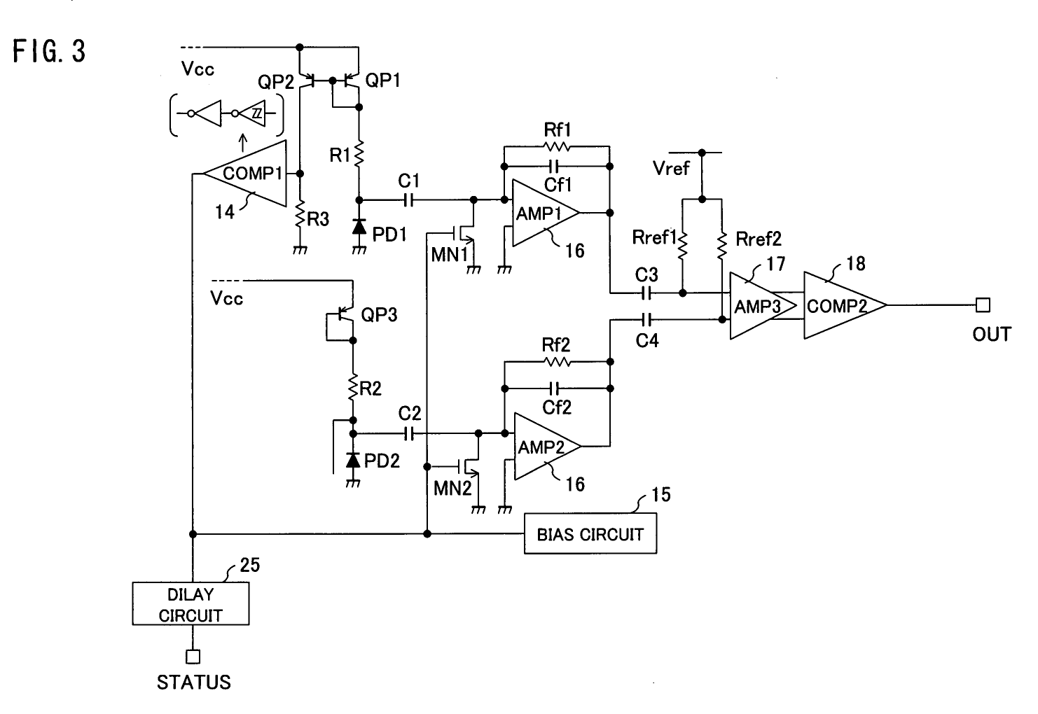

As illustrated in FIG. 3, a modulated light signal is converted to a current signal by the light receiving device PD1. When the optical receiver is in a waiting mode, a gate voltage of N channel MOSFET (MN1) is at high level. By switching MN1 on, one of terminals of a capacitor C1 is grounded to GND level. The filter circuit includes a resister R1 and the capacitor C1 that is grounded by turning MN1 on. The filter circuit transmits, to the resister R1, a low frequency current component of the current that runs in the light receiving device whereas it transmits a high frequency current component of the current to the capacitor C1.

To explain more in details, the current that runs into the resister R1 becomes a current signal transmitted through a low-pass filter which has cut off frequency of fc calculated by the formula below:
fc=1/{2π·(R1+Vt/IDC_{—}PD)·C1}
(where
Vt:k·T/q
K: Boltzman Constant
T: Absolute Temperature
q: Elementary Electric Charge
IDC_PD: A component of DC current that runs in the light receiving device PD1).
   The current that runs into the capacitor C1 becomes a current signal transmitted through a high-pass filter that has cut off frequency fc calculated by the formula above.

Because a duty ratio of a signal obtained by bi-phase mark modulation is kept at 50% (bi-phase mark modulation is frequently used for optical fiber communications such as an optical fiber link for digital audio, an in-vehicle fiber of MOST standard and the like), the signal is separated into a component of DC current and a component of AC current by the filter circuit (In the case of a bi-phase modulated signal of 25 Mbps, the signal is separated into a 50 MHz component of AC current and a 25 MHz component of AC current).

DC current that runs through the resister R1 is converted to voltage by a resister R3, after the direction of the current is changed by a current mirror that includes PNP transistors QP1 and QP2.

When incident light is weak (when a drop of voltage at R1 is small), bias voltage VR of the light receiving device PD1 can be set as high as Vcc−Vbe (For example, at Vcc=5V, supposing Vbe of QP1 is 0.6V, VR becomes 4.4V). Thus, parasitic capacitance becomes small when the light receiving device PD1 is a photodiode. This becomes advantageous to speeding up and lowering noise.

The current mirror may be arranged such that the ratio QP1:QP2 of emitter area is 1:N, whereby, the current may be amplified by N times by using the current mirror thus arranged. When the voltage across the resister R3 surpasses a threshold for the comparator COMP1, the output of the comparator COMP1 is switched over from high level to low level, so as to activate the bias circuit 15. The activation of the bias circuit 15 supplies bias current to the signal processing circuit 20, which comprises AMP1, AMP2, AMP3, and COMP2. As a result, the signal processing circuit 20 is activated (turns to an operating mode). Besides, MN1 is switched off by the change in the gate voltage of the N-channel MOSFET (MN1) to the low level. By this switching off, an AC current component which contains a modulated signal transmitted through the capacitor C1 is inputted to a current/voltage converter circuit. The current/voltage converter circuit is a current/voltage converter amplifier comprising AMP1, Rf1, and Cf1.

When AMP1 is activated, the input impedance of the current/voltage converter amplifier becomes low. This keeps the capacitor C1 grounded even when MN1 is off. It becomes another merit that the filter circuit comprising the resister R1 and the capacitor C1 has little change in such properties as cut off frequency and the like, during a waiting mode and an operating mode.

Furthermore, the light receiving device PD2 is a dummy light receiving device that has the same area as the light receiving device PD1. Blocking off the light receiving device PD2 by using a cathode electrode thereof is effective to attain a signal from which noise that is a similar phase component to a component of electromagnetic noise or noise of an electric source line. By connecting, to the dummy light receiving device PD2, elements equivalent to the elements connected to the light receiving device PD1 (R2=R1, C2=C1, MN2=MN1, AMP2=AMP1, Rf2=Rf1, Cf2=Cf1), an optical receiver resistant to electric source noise and disturbance noise can be realized.

The signal converted to voltage by AMP1 is inputted into AMP3 through the capacitor C3. Resistances Rref1 and Rref2 are connected to an input terminal of an amplifier AMP3 via a constant voltage source Vref and are resistances used for setting the operating point of AMP3 input. The signal mentioned above is amplified by AMP3. Then, its waveform is shaped by the comparator COMP2. After that the signal is outputted to an OUT terminal as a digital signal.

There is a time-lag between the moment when the output of COMP1 turns from high level to low level and the moment when the bias circuit and the signal processing circuit is activated. Accordingly, it is so configured that the output of COMP1 is connected to a STATUS terminal via a delaying circuit 25, whose damping time constant is set to be time longer than the time taken to stabilize the output of the signal processing circuit. In this configuration, when a light signal is inputted and output of the signal becomes stable enough, the STATUS terminal is inverted. This configuration allows the light signal to be used as an activating signal for a microcomputer connected to an OUT terminal.

In the connection where a CMOS Schmidt Trigger and an inverter are connected with each other, current runs only when output is inverted. By using the connection as shown in parenthese in FIG. 3 instead of the comparator COMP1, it becomes possible to reduce the current consumption of the optical receiver to substantially 0 at the time when a light signal does not come in.

### Embodiment 3

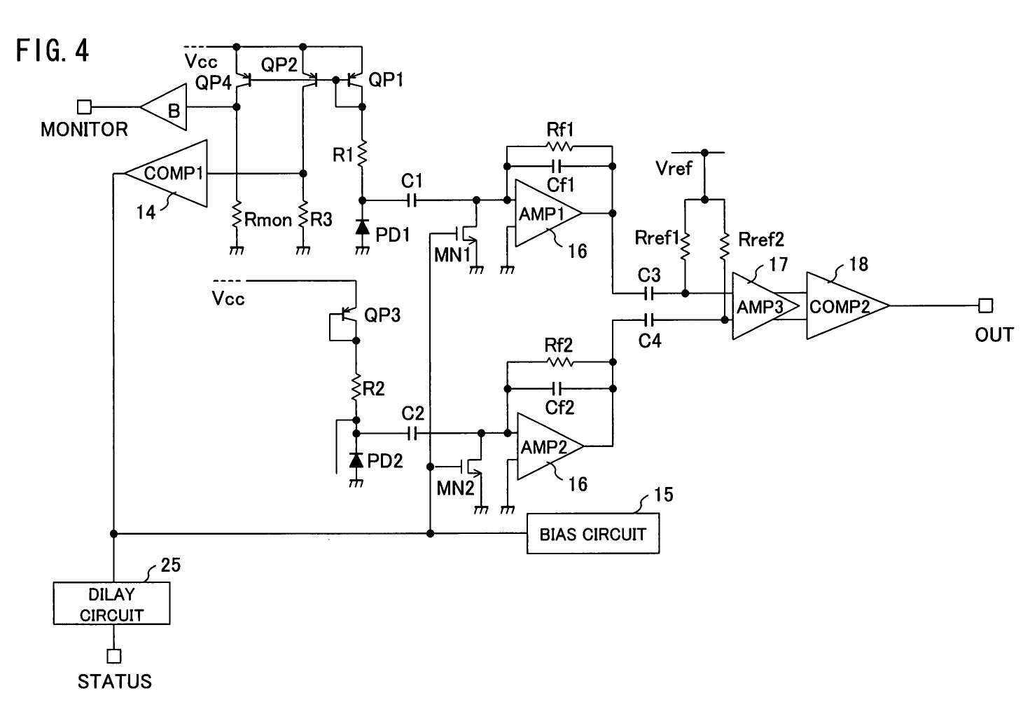

In addition to the configuration shown in the FIG. 3, a configuration of a present embodiment is arranged as follows, as illustrated in FIG. 4: a low frequency current that runs through the light receiving device PD1 is amplified by a current mirror comprising the PNP transistors QP1 and QP4. Then, the low frequency current is converted to voltage by a resister Rmon, and is outputted to a MONITOR terminal through a buffer B. This makes it possible to monitor intensity of a light signal that comes in the light receiving device PD1. Moreover, by comprising a current mirror and a window comparator, the optical receiver can be arranged such that it is turned to an operating mode only when a light signal in a certain range comes in the light receiving device.

### Embodiment 4

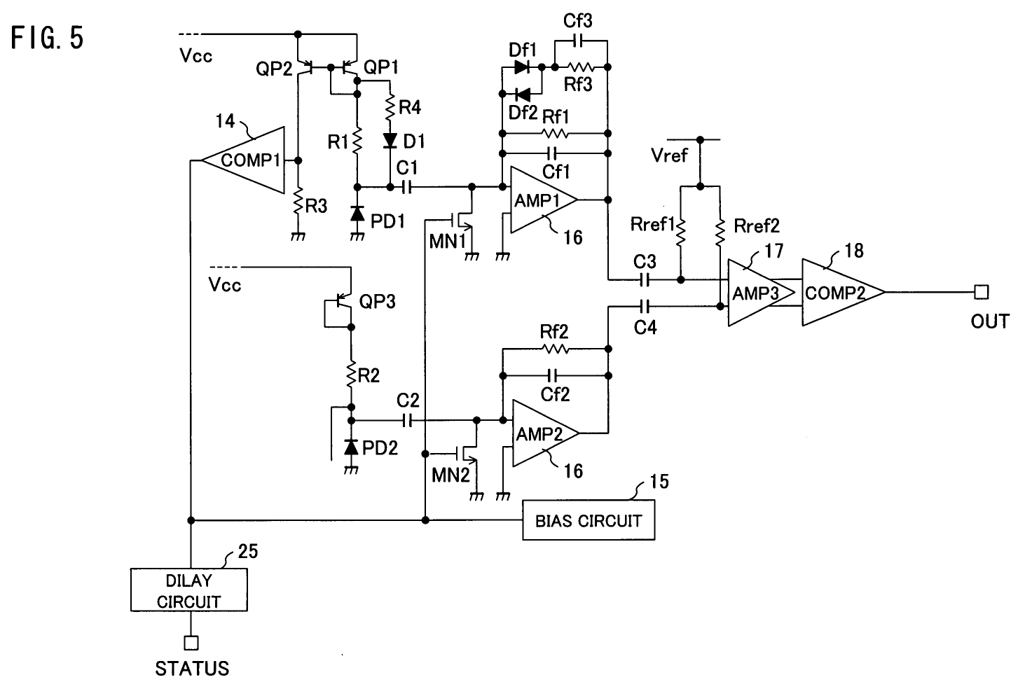

As illustrated in FIG. 5, a light receiving device is provided with a compression circuit comprising a diode Dl and a resister R4 in addition to the configuration shown in the FIG. 3. This arrangement makes it possible to prevent the bias voltage of the light receiving device PD1 from falling, because the configuration prevents a voltage drop of the resister R1 from becoming bigger even when high intensity light comes in. In general, resistance of the resister R4 is set to be around 1/10 of the resistance in the resister R1.

By providing a compression circuit comprising Df1, Df2, Rf3, and Cf3 to a current/voltage converter amplifier comprising AMP1, Rf1, and Cf1, it is possible to prevent output pulse width from being largely distorted even when a light signal of high intensity light is inputted.

Especially, the MOST standard for fibers for use in vehicles specifies that the range of light input should be from −2 dBm to −23 dBm, which is wider than a conventional input range of the light input for an optical fiber link for conventional digital audio of from −14 dBm to −24 dBm. Therefore, the configuration with a compression circuit has a wider dynamic range and thus is quite effective.

Furthermore, the input is AC coupled by C1. The signal that has a duty ratio of 50% and has been obtained by bi-phase modulation is two-way compressed by Df1 and Df2 interactively. By this, a threshold comes to exactly 50% of the signal. This advantageously allows decreasing of the distortion of the output pulse width.

### Embodiment 5

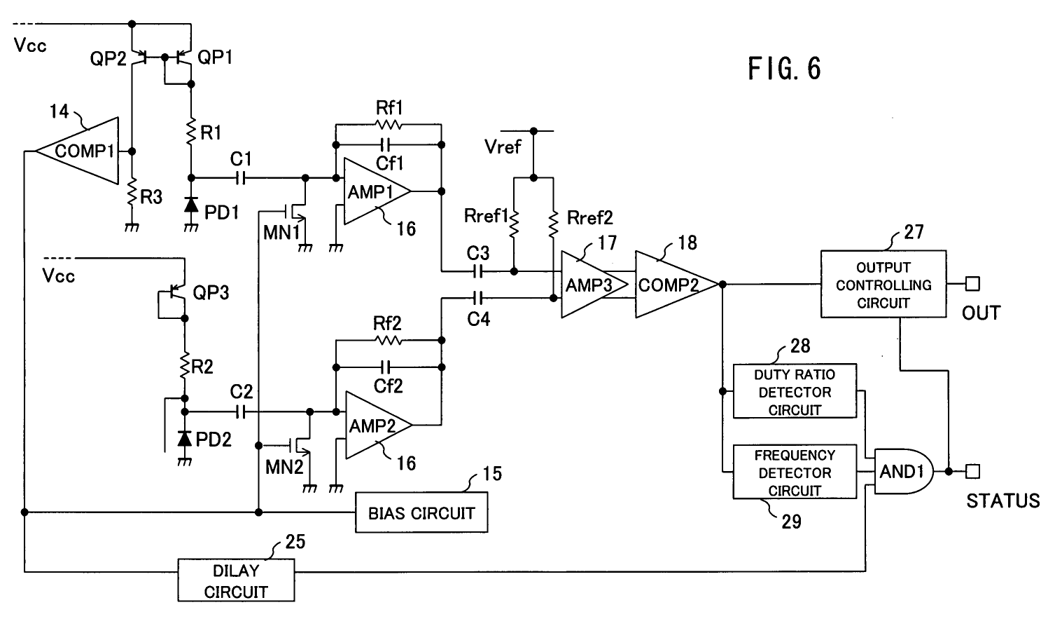

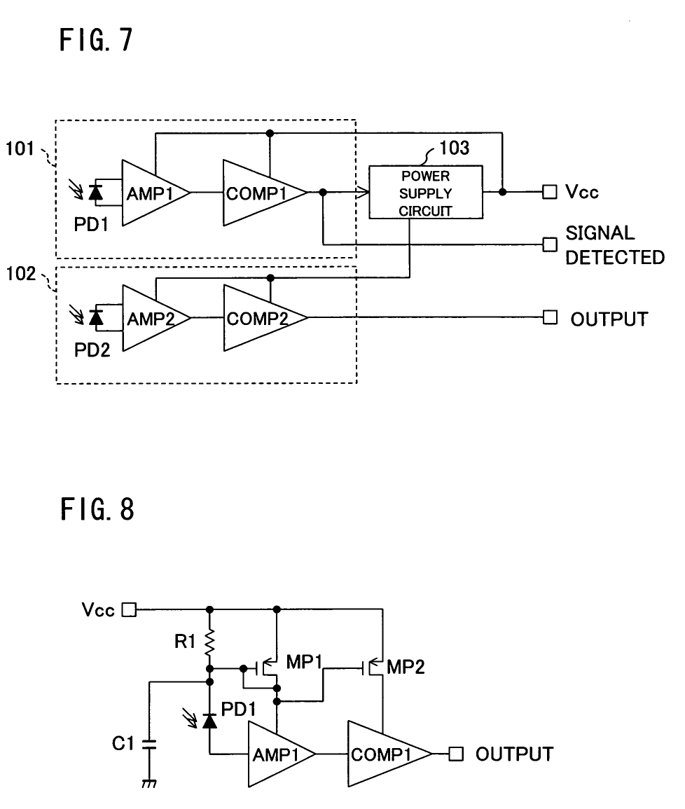

As illustrated in FIG. 6, an output controlling circuit 27 for controlling whether to transmit an output signal or not, a duty ratio detector circuit 28 for detecting duty ratio of output from a comparator COMP2, and a frequency detector circuit 29 for detecting frequency of output from the comparator COMP2 are provided in addition to the configuration illustrated in FIG. 3. The output controlling circuit 27 is located between a comparator COMP2 and OUT terminal. AND1 performs AND operation by using an output of the two detector circuits (28 and 29) and an activating signal transmitted from a bias circuit 15 via a delay circuit 25. A signal obtained by the AND operation is outputted via a STATUS terminal and used as a control signal for the output controlling circuit 27.

The respective two detector circuits (28 and 29) stores therein these output data of duty ratio and frequency from the comparator COMP2 which are supposed to be obtained when an input light signal is a correct modulated signal designated and desired. That is, these output data of duty ratio and frequency are designated as reference for the two detector circuits (28 and 29). The two detector circuits (28 and 29) detect whether the inputted duty ratio and the inputted frequency of the output from the comparator COMP2 are identical with the designated duty ratio and frequency. Only when the duty ratios and frequencies are identical, the two detector circuits (28 and 29) determine that an input light signal is a designated modulated signal, and output a true (high) signal.

This makes it possible to arrange such that a signal output terminal transmits an output signal only when the input light signal is the designated modulated signal.

As described above, in this present invention, the signal processing circuit is activated based on how large the low frequency current of a current signal generated by a light receiving device is. Namely, the present invention is arranged such that a DC current component (a component of low frequency current) of the light receiving device is detected and the receiving circuit is switched over from a shutdown mode as a waiting mode to an operating mode and vice versa, according to the result of the detection. The present invention thus arranged makes it possible to reduce the current consumption of the optical receiver to substantially 0 (equivalent to leak current of a device) at the time when a light signal doesn't come in.

Besides, this invention realizes an optical receiver that is so effective in lowering the power consumption that it does not need a shut-down signal from outside in order to attain lower power consumption.

Moreover, this invention is also applicable to attain an optical receiver in which an amount of current flow during a waiting mode is reduced.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. An optical receiver including a signal processing circuit for performing output process for data received at a light receiving device, the optical receiver comprising:
a filter circuit for separating low frequency current and high frequency current from a current signal generated by said light receiving device;
a current/voltage converter circuit for converting said low frequency current to voltage; and
a bias circuit for activating said signal processing circuit in response to output of said current/voltage converter circuit.

2. The optical receiver as in claim 1, wherein:
said filter circuit includes a resister, a capacitor, and a grounding switch device, said resister and said capacitor connected to said light receiving device so that said light receiving device is connected to said signal processing circuit via said capacitor, and said grounding switch device provided between said capacitor and said signal processing circuit and being switched over by said bias circuit so that said ground switch device is switched to be grounded during a waiting mode.

3. The optical receiver as in claim 2, wherein:
said signal processing circuit includes a first current/voltage converter circuit and a second current/voltage converter circuit following said first current/voltage converter circuit and has input impedance lowered when said first current/voltage converter circuit is activated.

4. The optical receiver as in claim 3, comprising:
a compressor circuit, parallel-connected with said resister attached to said light receiving device.

5. The optical receiver as in claim 3, comprising:
a two-way compressor circuit, parallel-connected with a feedback resister of said first current/voltage converter circuit in said signal processing circuit.

6. The optical receiver as in claim 1, wherein:
said current/voltage converter circuit includes:
a current mirror for amplifying current;
a resister for voltage conversion; and
a comparator for outputting an instruction to a bias circuit, when voltage across said resister for voltage conversion surpasses a certain level of voltage, in order to switch said signal processing circuit to an operating mode.

7. The optical receiver as in claim 6, wherein:
output of said comparator is outputted to outside as a status signal.

8. The optical receiver as in claim 7, wherein:
output of said comparator is outputted as said status signal to outside through a delay circuit that has a time constant longer than time said signal processing circuit takes to become stable.

9. The optical receiver as in claim 7 comprising,
an output controlling circuit, between output of said signal processing circuit and a signal output terminal, said output controlling circuit for causing said signal output terminal to output a signal from said signal processing circuit therethrough only when duty ratio and frequency of the signal to be outputted from said signal processing circuit are respectively equal to designated duty ratio and frequency which an output signal of said signal processing circuit has when an inputted light signal is a designated and desired correct modulation signal.

10. The optical receiver as in claim 6, comprising:
a monitor terminal for monitoring intensity of light that comes in said light receiving device;
a current mirror; and
a resister, said current mirror and said resister connected with each other.
